(19) United States
(12) Patent Application Publication
(10) Pub. No.: US 2017/0041605 A1
(43) Pub. Date: Feb. 9, 2017

(54) VIDEO ENCODING DEVICE AND VIDEO ENCODING METHOD

(71) Applicant: FUJITSU LIMITED, Kawasaki-shi (JP)

(72) Inventor: Yasuhiro Watanabe, Kawasaki (JP)

(73) Assignee: FUJITSU LIMITED, Kawasaki-shi (JP)

(21) Appl. No.: 15/224,500

(22) Filed: Jul. 29, 2016

(30) Foreign Application Priority Data
Aug. 4, 2015 (JP) 2015-154170

(51) Int. Cl. H04N 19/119; H04N 19/176; H04N 19/61; H04N 19/30; H04N 19/167; H04N 19/174; H04N 19/159; H04N 19/527; H04N 19/172; H04N 19/15

(52) U.S. Cl. CPC H04N 19/119; H04N 19/172; H04N 19/176; H04N 19/61; H04N 19/15; H04N 19/167; H04N 19/174; H04N 19/159; H04N 19/527; H04N 19/30

(57) ABSTRACT

A video encoding device includes a processor configured to: generate a reduced picture based on a picture in video data; encode each of a plurality of first blocks divided from the reduced picture; set a first region in the picture; restrict a coding mode usable for each second block included in the first region among a plurality of second blocks divided from the picture, to a first coding mode which refers to the first block in the reduced picture corresponding to the second block or a second coding mode which refers to the first region; and encode, for each second block in the first region, a prediction error signal between the second block and the prediction block generated in accordance with the first or second coding mode.

### CROSS-REFERENCE TO RELATED APPLICATION

This application is based upon and claims the benefit of priority of the prior Japanese Patent Application No. 2015-154170, filed on Aug. 4, 2015, and the entire contents of which are incorporated herein by reference.

### FIELD

The embodiments discussed herein are related to a video encoding device, a video encoding method and a computer program for video encoding.

### BACKGROUND

Video data generally includes a large amount of data. In particular, video data in accordance with a standard with a large number of pixels, such as 4K or 8K, may include a very large amount of data. Thus, computing power which is necessary for an apparatus encoding or decoding such video data is increasing.

On the other hand, in some decoding devices, calculation capability may be insufficient to decode video data with quality almost equivalent to the original quality from encoded video data. In view of this, scalable coding technique has been proposed as a technique for adaptively distributing video data with different quality according to calculation capability of a decoding device. In the scalable coding technique, it is possible to reduce a resolution of each picture or a frame rate included in the video data less than an original resolution or frame rate when decoding encoded video data. The reduction of the resolution or frame rate allows a required level for calculation capability to be low.

Depending on an application, it may be acceptable if a partial region of a picture is reproduced with the original quality and other regions with lower quality. Alternatively, it may be acceptable if only partial region of a picture is decoded. However, when coding video data, a picture is normally divided into a plurality of blocks to encode each block by a raster scan order, for example. Then, when encoding a target block, information regarding an already-encoded block is referred to. Therefore, as a general rule, it is difficult to decode only an arbitrary region in a picture, or to make a resolution of a decoded arbitrary region different from a resolution of another region. For example, when encoding the target block according to an intra-prediction coding mode which refers to an encoded region of a coding-target picture, a value of a pixel adjacent to the left side or the upper side of the target block may be referred to for generating a prediction block. When encoding the target block according to an inter-prediction coding mode which refers to a picture encoded before the coding-target picture, an error between a motion vector and a prediction vector obtained for the target block may be encoded in some cases. When determining the prediction vector, a motion vector of a block adjacent to the left side, the upper side or upper right of the target block may be referred to in some cases. In view of this, a technique which encodes video data so that only a partial region of a picture can be decoded or a resolution of a decoded region is selectable only in the partial region has been proposed (e.g., example, refer to Japanese Laid-open Patent Publication No. 2007-174568 and International Patent Publication No. 2014/002619).

For example, a coding method disclosed in Japanese Laid-open Patent Publication No. 2007-174568 includes dividing the entire video frame region into an interactive ROI region and a non-ROI region other than the interactive ROI region, and reducing the interactive ROI region and the non-ROI region to convert the regions into low resolution images. The coding method then encodes the interactive ROI region having a low resolution and that having a high resolution independently, in the unit of slice, to generate hierarchical coded data with space scalability. On the other hand, the coding method generates coding data without space scalability about the non-ROI region.

The image decoding device disclosed in International Patent Publication No. 2014/002619 acquires a first parameter indicating which tile a region of interest tile is from a coding stream encoded by dividing an image into a plurality of tiles. The image decoding device then decodes at least one of the region of interest tile and the region of non-interest tile of an image on the basis of the first parameter.

### SUMMARY

In the technique disclosed in Japanese Laid-open Patent Publication No. 2007-174568 and the technique disclosed in International Patent Publication No. 2014/002619, slices or tiles are utilized in order to only decode an arbitrary region in a picture, or provide the space scalability in decoding, to only an arbitrary region. However, division of the picture by a slice or a tile includes limitation. Therefore, depending on the position of a region on which partial decoding is performed or to which the scalability is provided, it may be needed to set a different boundary of a slice or a tile for each boundary of the region. In this case, the number of slices or tiles set in a picture increases, to decrease encoding efficiency.

According to one embodiment, a video encoding device is provided. The video encoding device includes a processor configured to: down-sample a picture included in video data to generate a reduced picture; divide the reduced picture into a plurality of first blocks; encode each of the plurality of first blocks; set a first region in the picture; restrict a coding mode usable for each second block included in the first region among a plurality of second blocks divided from the picture, among a plurality of coding modes each defining a method of generating a prediction block, to a first coding mode which refers to the first block in the reduced picture corresponding to the second block or a second coding mode which refers to the first region in the picture; generate, for each second block in the first region, a prediction block in accordance with the first coding mode or the second coding mode; and encode a prediction error signal obtained by performing difference calculation between the prediction block and the second block.

According to another embodiment, the video decoding device is provided. The video decoding device includes a processor configured to: extract, from encoded video data, first encoded data obtained by encoding each of the plurality of first blocks obtained by dividing a reduced picture generated by down-sampling a picture included in the video data, region information indicating a first region set in the picture, and second encoded data obtained by encoding a second block in the first region among a plurality of second blocks divided from the picture in accordance with a first coding mode which refers to the first block in the reduced picture corresponding to the second block or a second coding mode which refers to the first region in the picture; decode the reduced picture from the first encoded data; and decode the first region of the picture from the second encoded data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a video encoding device according to an embodiment.

FIG. 2 is a diagram illustrating a relationship between a region of interest (ROI) and each of a first-restriction target block and a second-restriction target block.

FIG. 3 is a diagram illustrating a listing of prediction modes each defining pixels to be referred to for generating a prediction block when the intra-prediction coding mode is used according to H.264.

FIG. 4 is an operation flowchart of a coding-mode restriction setting process.

FIG. 5 is a block diagram of an upper-layer encoding unit.

FIG. 6 is a diagram illustrating an example of a bitstream including encoded video data.

FIG. 7 is an operation flowchart of a video encoding process.

FIG. 8 is a schematic configuration diagram of a video decoding device according to one embodiment.

FIG. 9 is an operation flowchart of a video decoding process.

FIG. 10 is a schematic configuration diagram of an image analysis device corresponding to a modified example.

FIG. 11 is a diagram illustrating an example of ROIs set in an upper-layer picture and a decoding-target partial region specified by a rough-analysis unit.

FIG. 12 is a configuration diagram of a computer configured to operate as a video encoding device or a video decoding device.

### DESCRIPTION OF EMBODIMENTS

A video encoding device is described below with reference to the drawings. This video encoding device performs spatial scalable coding on pictures included in video data. In addition, the video encoding device sets partially decodable regions of interest (ROIs) on an original picture, i.e., an upper-layer picture. The video encoding device excludes a coding mode in which any block outside an ROI is referred to, from coding modes that can be used for each block in the ROI among a plurality of coding modes each defining a method of generating a prediction block. Specifically, the video encoding device restricts coding modes usable for each block in the ROI to those in which a prediction block or prediction vector is generated by referring to a block in the ROI or a corresponding block in a reduced lower-layer picture having a relatively low resolution. For example, the video encoding device restricts coding modes usable for each block adjacent to the left side or the upper side of the ROI to the inter-layer intra-prediction coding mode or the inter-layer inter-prediction coding mode. Moreover, the video encoding device employs, for each block that is not adjacent to the upper side of the ROI and is adjacent to the right side of the ROI, the inter-layer intra-prediction coding mode, inter-layer inter-prediction coding mode, or the intra-prediction coding mode in which no pixels on the upper right of the block are referred to. The inter-layer intra-prediction coding mode is a coding mode for generating a prediction block on the basis of a corresponding block in a reduced lower-layer picture corresponding to a block in an upper-layer picture. The inter-layer inter-prediction coding mode is a coding mode for generating a prediction vector for motion vector of a block in an upper-layer picture by performing scale adjustment on the motion vector of the corresponding block in a reduced lower-layer picture corresponding to the block. Even when the inter-layer inter-prediction coding mode is used, a prediction block and a motion vector are calculated on the basis of an upper-layer picture that is previous to the upper-layer picture including the coding-target block in a coding order.

In some cases, the inter-prediction coding mode and the inter-layer inter-prediction coding mode may be used, and an ROI may be set in a locally decoded picture to be referred to. In this case, the video encoding device restricts a search range of a motion vector within the ROI so that a prediction block can be generated by using only pixels in the ROI in the locally decoded picture to be referred to.

With this configuration, the video encoding device enables each block in the ROI to be independent of any of the other regions in an upper-layer picture, except for dependency of a variable-length coding process. For this reason, to decode encoded video data, the video decoding device can decode the ROI without decoding any region outside the ROI in the upper-layer picture.

In this embodiment, the video encoding device encodes video data according to H.264, which is one of the coding standards usable in which spatial scalable coding can be used. However, the video encoding device may encode video data according to any other coding standards in which spatial scalable coding can be used.

A picture may be any of a frame or a field. A frame is a single still image in video data, whereas a field is a still image obtained by extracting data in odd-numbered rows or even-numbered rows.

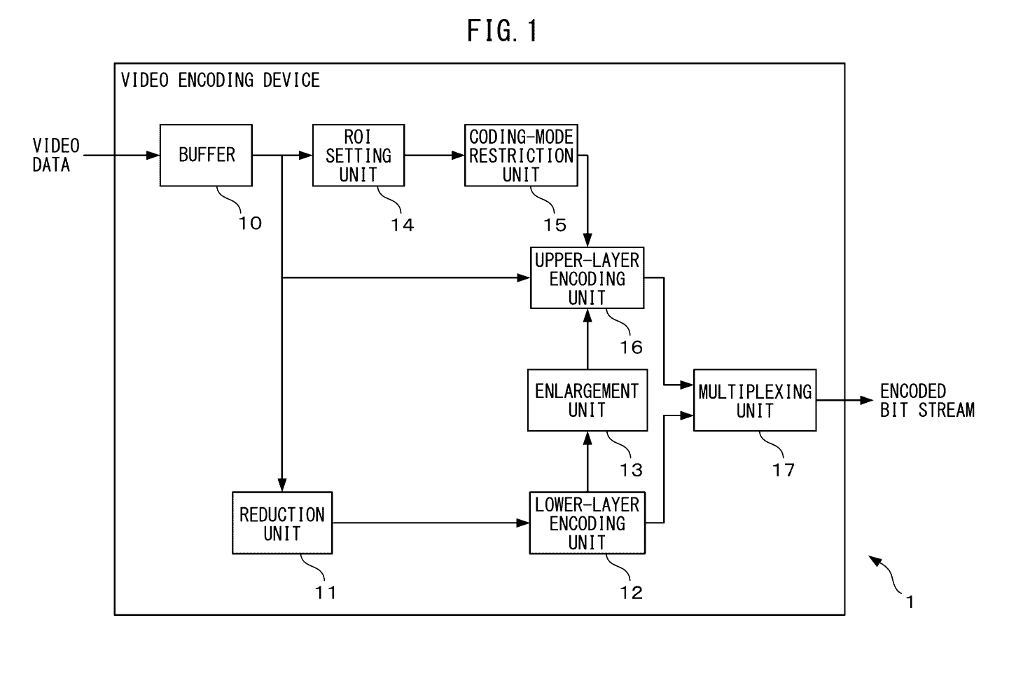

FIG. 1 is a schematic configuration diagram of a video encoding device according to an embodiment. A video encoding device 1 includes a buffer 10, a reduction unit 11, a lower-layer encoding unit 12, an enlargement unit 13, an ROI setting unit 14, a coding-mode restriction unit 15, an upper-layer encoding unit 16, and a multiplexing unit 17.

These units included in the video encoding device 1 are formed as separate circuits. Alternatively, these units included in the video encoding device 1 may be mounted in the video encoding device 1 as a single or multiple integrated circuits into which circuits corresponding to the units are integrated. Further, the units included in the video encoding device 1 may be functional modules implemented by a computer program executed on one or multiple processors included in the video encoding device 1.

The pictures included in video data are input to the buffer 10 in the reproduction order. The pictures stored in the buffer 10 are sequentially read out in the order of picture coding set by a control unit (not illustrated) configured to control the entire video encoding device 1. Each read picture is then input to the reduction unit 11, the ROI setting unit 14, and the upper-layer encoding unit 16.

The reduction unit 11 down-samples each input picture to generate a reduced picture having pixels fewer than those of the input picture. The reduced picture is a lower-layer picture having a relatively low resolution compared with that of the original picture, which is an upper-layer picture. For example, when the input picture has n pixels horizontally while having m pixels vertically and has a horizontal reduction ratio d1 while having a vertical reduction ratio d2, the reduction unit 11 generates a reduced picture having n*d1 pixels horizontally and m*d2 pixels vertically. Each of the reduction ratios d1 and d2 is a positive value smaller than or equal to one, for example, ½.

The reduction unit 11 smooths the input picture by applying a smoothing filter, such as a Gaussian filter or an averaging filter, to the pixels of the picture. The reduction unit 11 then sub-samples a smoothed picture, according to the horizontal and vertical reduction ratios, to generate a reduced picture.

The reduction unit 11 outputs the reduced picture to the lower-layer encoding unit 12.

Every time a reduced lower-layer picture is input, the lower-layer encoding unit 12 encodes the reduced picture.

The lower-layer encoding unit 12 divides the reduced picture into multiple blocks, for example. In this case, each block has a size of, for example, 16 pixels horizontally by 16 pixels vertically. For example, when the original picture is divided into blocks each formed by 16 pixels horizontally by 16 pixels vertically and each of the horizontal and vertical reduction ratios is ½, the size of a region in the reduced lower-layer picture corresponding to a block in the original picture is 8 pixels horizontally by 8 pixels vertically.

The lower-layer encoding unit 12 calculates the difference value between a pixel of each block and a corresponding pixel of the prediction block of the block, as a prediction error signal. The lower-layer encoding unit 12 generates a prediction block so that the coding cost, which is an estimation value of the code amount, is to be the lowest. For the generation, the lower-layer encoding unit 12 determines coding modes usable for the reduced picture, by referring to the type (I picture, P picture, or B picture) of the picture. The types of the original picture and the reduced picture are determined, for example, on the basis of a group of pictures (GOP) structure applied by the control unit (not illustrated) for the coding-target video data and the position of the original picture in the GOP.

For example, when the coding-target reduced picture is an I picture, for which the intra-prediction coding mode is used, the lower-layer encoding unit 12 generates, for each block, a prediction block on the basis of the values of the encoded pixels around the block so that the coding cost is to be the lowest.

On the other hand, when the coding-target picture is a P picture or a B picture, for which the inter-prediction coding mode can be used, the lower-layer encoding unit 12 obtains, for each block, a prediction block by performing motion compensation on a reduced picture that is encoded once and then decoded. In the following description, a reduced picture that is once encoded and then decoded is referred to as a locally decoded reduced picture. The lower-layer encoding unit 12 then obtains prediction blocks by the use of the values of encoded pixels around the block. The lower-layer encoding unit 12 uses the prediction block corresponding to the lowest coding cost among the prediction blocks, in order to generate a prediction error signal.

The lower-layer encoding unit 12 performs orthogonal transform on each prediction error signal of each block to obtain orthogonal-transform coefficients, and quantizes the orthogonal-transform coefficients. The lower-layer encoding unit 12 performs variable-length coding on the quantized orthogonal-transform coefficients. The lower-layer encoding unit 12 may perform variable-length coding also on information to be used for the generation of a prediction block, for example, the motion vector. Through such operation, the lower-layer encoding unit 12 encodes each reduced picture. The lower-layer encoding unit 12 then outputs encoded data of the reduced picture to the multiplexing unit 17.

In addition, the lower-layer encoding unit 12 reproduces the values of the pixels of each block on the basis of the quantized orthogonal-transform coefficients of the block. For this operation, the lower-layer encoding unit 12 performs inverse quantization on the quantized orthogonal-transform coefficients of each block, to reproduce the orthogonal-transform coefficients. The lower-layer encoding unit 12 performs inverse orthogonal transform on the reproduced orthogonal-transform coefficients of each block to reproduce the prediction error signals of the block, and adds each prediction error signal to the value of the corresponding pixel of the corresponding prediction block to reproduce the pixel values of the block. When the pixel values of all the blocks of the coding-target reduced picture are reproduced, the entire reduced picture is reproduced. The lower-layer encoding unit 12 stores the reproduced reduced picture in a memory (not illustrated) included in the lower-layer encoding unit 12 or accessible by the lower-layer encoding unit 12, as a locally decoded reduced picture. The lower-layer encoding unit 12 further stores, in the memory, the motion vector obtained for each block encoded in the inter-prediction coding mode among the blocks of the locally decoded reduced picture.

The enlargement unit 13 up-samples the blocks of the locally decoded reduced picture to be referred to for encoding an upper-layer picture by the upper-layer encoding unit 16. The enlargement unit 13 further enlarges the motion vector of each block of the locally decoded reduced picture.

For example, the enlargement unit 13 generates a prediction block having the same size as that of the corresponding block in the upper-layer picture by applying an up-sampling filter defined in the scalable coding in H.264 to blocks of the locally decoded reduced picture. When the video encoding device 1 is based on a coding standard other than H.264, the enlargement unit 13 may apply a different up-sampling filter. The enlargement unit 13 enlarges the motion vector of each block of the locally decoded reduced picture by multiplying each of the horizontal component and vertical component of the motion vector by the inverse of the corresponding reduction ratio. The motion vector thus enlarged can be used as a prediction vector for the coding of the motion vector of the upper-layer picture.

The enlargement unit 13 outputs the prediction block and the prediction vector to the upper-layer encoding unit 16.

The ROI setting unit 14 sets an ROI in an original picture of the video data, i.e., an arbitrary picture among the upper-layer pictures. For example, the ROI setting unit 14 acquires information specifying the coordinates of the upper left corner and the lower right corner of the ROI, or the upper left corner of the ROI and the horizontal and vertical sizes of the ROI, via a user interface (not illustrated), such as a keyboard or a mouse. The ROI setting unit 14 sets the ROI in the picture according to the information.

Alternatively, the ROI setting unit 14 may detect a region including a target object in each picture, by using a classifier configured to detect a predetermined target object, for each upper-layer picture. The ROI setting unit 14 may determine the detected region as an ROI. For example, when a target object is a human face, the ROI setting unit 14 can use, as a classifier, an AdaBoost classifier configured to input a Haar-like feature amount. In this case, the ROI setting unit 14 calculates multiple Haar-like feature amounts in a window set in a target picture. The ROI setting unit 14 then inputs the Haar-like feature amounts to the AdaBoost classifier, to determine whether the window is a face region including a face. When the ROI setting unit 14 determines that the window is a face region, the ROI setting unit 14 determines the window to be an ROI.

When a target object is a person, the ROI setting unit 14 can use, as a classifier, a RealAdaBoost classifier configured to input a histograms of oriented gradients (HOG) feature amount. In this case, the ROI setting unit 14 calculates multiple HOG feature amounts in a window set in a target picture. The ROI setting unit 14 then inputs the HOG feature amounts to the RealAdaBoost classifier, to determine whether the window is a person region including a person. When the ROI region setting unit 14 determines that the window is a person region, the ROI setting unit 14 determines the window to be an ROI.

The ROI setting unit 14 may set multiple ROIs in the picture by repeating the above-described process while changing the position and the size of the window. When there is no target region in the target picture, the ROI setting unit 14 does not need to set any ROI in the target picture.

The ROI setting unit 14 outputs, for each picture, information indicating the ROI set in the picture, to the coding-mode restriction unit 15 and the multiplexing unit 17. The information indicating an ROI includes, for example, the coordinates of the upper left corner of the ROI and the horizontal and vertical sizes of the ROI.

The coding-mode restriction unit 15 sets, for each upper-layer picture, restriction-target blocks, for which usable coding modes are restricted, among the blocks included in the ROI in the picture. The coding-mode mode restriction unit 15 also determines coding modes usable for each restriction-target block.

When the intra-prediction coding mode is applied for a target block, a prediction block of the target block is normally generated by referring to the values of the pixels adjacent to the left of the target block or the values of the pixels adjacent to the upper side or upper right of the target block. When the inter-prediction coding mode is applied for a target picture, a prediction vector to be used for encoding the motion vector of the target block is selected from the motion vectors of the left or upper side of the target block. For this reason, when no restriction on usable coding modes is applied to the blocks adjacent to the left side or upper side of the ROI, pixels not included in the ROI may be referred to for encoding the blocks. Moreover, pixels not included in the ROI are referred to for the block positioned at the right side of the ROI in some prediction modes each defining pixels to be referred to when the intra-prediction coding mode is used.

The coding-mode restriction unit 15 sets each block adjacent to the left side or the upper side of the ROI as a first-restriction target block. In addition, the coding-mode restriction unit 12 sets each block that is not adjacent to the upper side of the ROI and is positioned at the right side of the ROI, as a second-restriction target block. The first-restriction target block and the second-restriction target block have different restrictions in terms of the use of the intra-prediction coding mode. The coding-mode restriction unit 15 does not set any restrictions on usable coding modes, for any block that is not adjacent to any of the left side, the upper side, and the right side of the ROI and any block not included in the ROI.

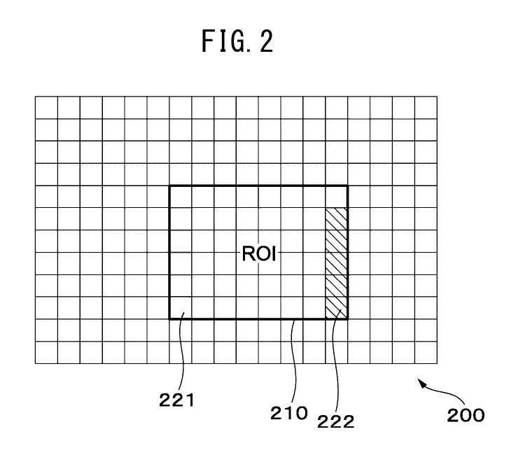

FIG. 2 is a diagram illustrating a relationship between an ROI and each of first-restriction target blocks and second-restriction target blocks. Each rectangle in a picture 200 represents a block serving as a unit of a coding process. Each block 221, which is adjacent to the left side or the upper side of an ROI 210 among the blocks included in the ROI 210 set in the picture 200, is a first-restriction target block. Each block 222, which is not adjacent to the upper side of the ROI 210 and is adjacent to the right side of the ROI 210, is a second-restriction target block.

In this embodiment, coding modes usable for a first-restriction target block include the inter-layer inter-prediction coding mode and the inter-layer intra-prediction coding mode. Specifically, when the inter-layer inter-prediction coding mode is applied for a first-restriction target block, a prediction vector of the motion vector of the first-restriction target block is generated on the basis of the motion vector of the corresponding block in a locally decoded reduced picture. On the other hand, when the inter-layer intra-prediction coding mode is applied for a first-restriction target block, a prediction block of the first-restriction target block is generated by the enlargement unit 13 up-sampling the corresponding block of a locally decoded reduced picture.

On the other hand, coding modes usable for the second-restriction target block include the inter-layer inter-prediction coding mode and the inter-layer intra-prediction coding mode as well as prediction modes of the intra-prediction coding mode in which no pixels on the upper right of the second-restriction target block are referred to.

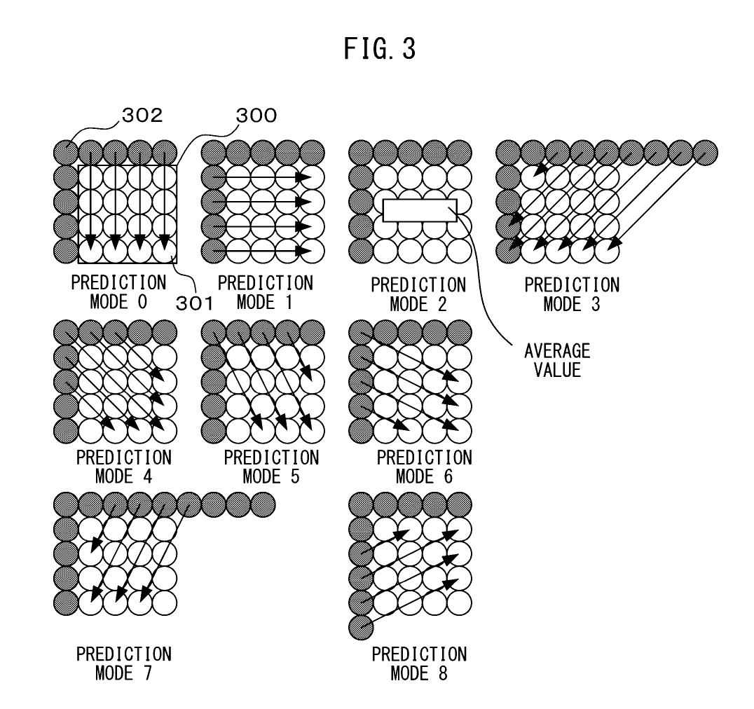

FIG. 3 is a diagram illustrating a listing of prediction modes each defining pixels to be referred to for generating a prediction block when the intra-prediction coding mode is used according to H.264. In FIG. 3, white circles 301 represent pixels in a coding-target block 300, and black circles 302 represent pixels to be referred to for generating a prediction block. In H.264, nine kinds of prediction modes, i.e. Prediction mode 0 to Prediction mode 8, are defined as prediction modes. In Prediction mode 3 and Prediction mode 7 among these prediction modes, pixels positioned on the upper right of the coding-target block are referred to. Hence, the use of Prediction mode 3 and Prediction mode 7 is prohibited for a second-restriction target block.

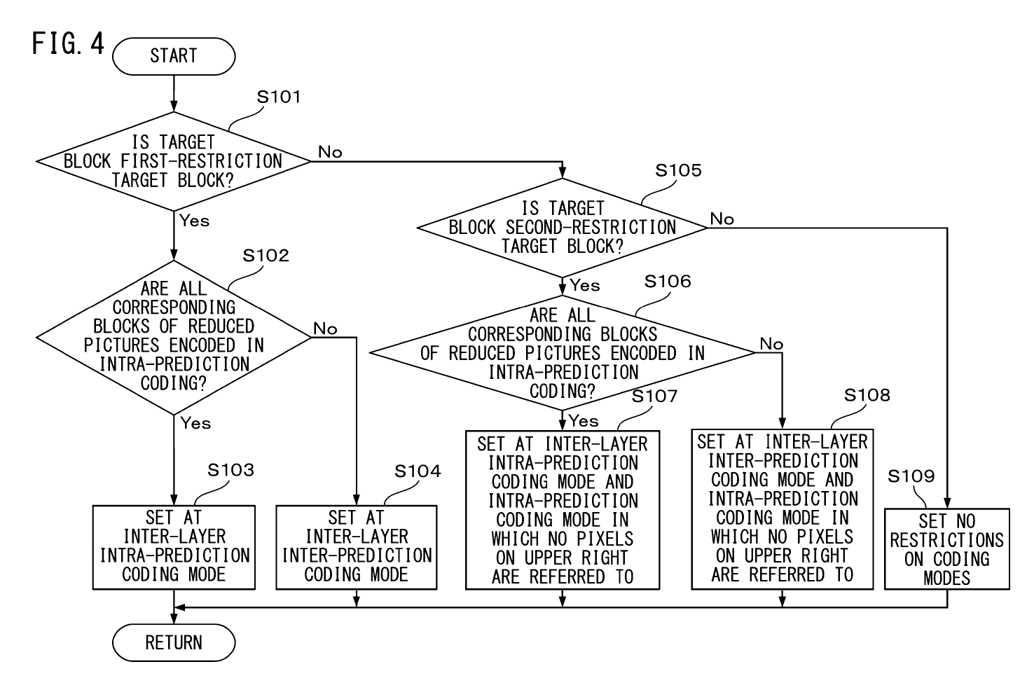

FIG. 4 is an operation flowchart of a coding-mode restriction setting process by the coding-mode restriction unit 15. The coding-mode restriction unit 15 sets, for each block in the ROI, restrictions on coding modes in accordance with the following operation flowchart.

The coding-mode restriction unit 15 determines whether a target block is a first-restriction target block (Step S101). When the target block is a first-restriction target block (Yes in Step S101), the coding-mode restriction unit 15 determines whether the intra-prediction coding is performed on each of all the corresponding blocks located at the same position as that of the target block in the locally decoded reduced pictures (Step S102). When the intra-prediction coding is performed on each of all the corresponding blocks in the locally decoded reduced picture (Yes in Step S102), the coding-mode restriction unit 15 sets the inter-layer intra-prediction coding mode as a coding mode usable for the target block (Step S103).

On the other hand, when the inter-prediction coding is performed on one or more of the corresponding blocks in the locally decoded reduced pictures (No in Step S102), the coding-mode restriction unit 15 sets the inter-layer inter-prediction coding mode as a coding mode usable for the target block (Step S104).

When the target block is not a first-restriction target block in Step S101 (No in Step S101), the coding-mode restriction unit 15 determines whether the target block is a second-restriction target block (Step S105). When the target block is a second-restriction target block (Yes in Step S105), the coding-mode restriction unit 15 determines whether the intra-prediction coding is performed on each of all the corresponding blocks in the locally decoded reduced pictures (Step S106). When the intra-prediction coding is performed on each of all the corresponding blocks in the locally decoded reduced picture (Yes in Step S106), the coding-mode restriction unit 15 sets the inter-layer intra-prediction coding mode and the prediction modes of the intra-prediction coding mode in which no pixels on the upper right are referred to, as coding modes usable for the target block (Step S107).

On the other hand, when the inter-prediction coding is performed on any of the coding blocks in the locally decoded reduced pictures (No in Step S106), the coding-mode restriction unit 15 sets the inter-layer inter-prediction coding mode and the prediction modes of the intra-prediction coding mode in which no pixels on the upper right of the target block are referred to, as coding modes usable for the target block (Step S108).

When the target block is not a second-restriction target block in Step S105 (No in Step S105), the coding-mode restriction unit 15 does not set any restrictions on coding modes for the target block (Step S109). After Step S103, S104, S107, S108, or S109, the coding-mode restriction unit 15 terminates the coding-mode restriction setting process.

The coding-mode restriction unit 15 notifies the upper-layer encoding unit 16 of the restrictions on coding modes for each block of the picture.

The upper-layer encoding unit 16 encodes each upper-layer picture in the video data. In the coding, the upper-layer encoding unit 16 divides a coding-target picture into multiple blocks and encodes each block. The upper-layer encoding unit 16 encodes each block in an ROI set in the picture so that the restrictions on coding modes set for a first-restriction target block and a second-restriction target block are to be kept, in order to be able to decode the ROI independently.

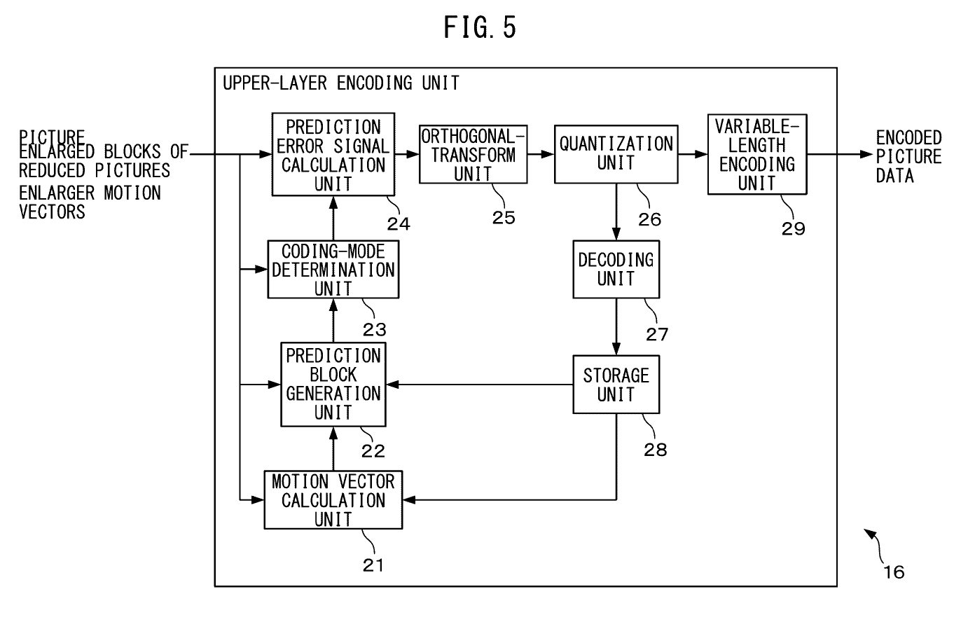

FIG. 5 is a block diagram of the upper-layer encoding unit 16. The upper-layer encoding unit 16 includes a motion vector calculation unit 21, a prediction block generation unit 22, a coding-mode determination unit 23, a prediction error signal calculation unit 24, an orthogonal-transform unit 25, a quantization unit 26, a decoding unit 27, a storage unit 28, and a variable-length encoding unit 29.

When the coding-target picture is a picture for which the inter-prediction coding mode can be used, such as a P picture or a B picture, the motion vector calculation unit 21 calculates a motion vector of a coding-target block in the coding-target picture. In the calculation, the motion vector calculation unit 21 performs block matching on each locally decoded picture that is already encoded and can be referred to for the coding-target picture, and determines the locally decoded picture having the best match with the coding-target block and the position of the corresponding region in the locally decoded picture. The motion vector calculation unit 21 then calculates the vector representing the spatial move amount between the coding-target block and the region, as a motion vector.

When an ROI is set in a locally decoded picture to be referred to for the coding-target block, the motion vector calculation unit 21 restricts the search range for a motion vector within the ROI so as to be able to generate a prediction block by using only the pixels within the ROI in the locally decoded picture to be referred to. With this configuration, even when the ROI of the locally decoded picture is only the block that is to be encoded, the coding-target block can also be decoded.

The motion vector calculation unit 21 outputs, for each block in the coding-target picture, information indicating the motion vector and the locally decoded picture referred to for the motion vector, to the prediction block generation unit 22 and the coding-mode determination unit 23.

The prediction block generation unit 22 generates, for each block in the coding-target picture, a prediction block for each coding mode usable for the block. In the generation, when a target block is a first-restriction target block or a second-restriction target block, the prediction block generation unit 22 generates a prediction block by using a coding mode that keeps the restrictions on coding modes set for the block.

For example, when the coding-target picture is a picture for which the inter-prediction coding mode is usable, the prediction block generation unit 22 generates a prediction block by performing motion compensation on the region in the locally decoded picture indicated by the motion vector calculated for the target block. When a block adjacent to the left side or the upper side of the target block is encoded by the inter-prediction coding and the inter-prediction coding mode is usable, the prediction block generation unit 22 sets the motion vector of the adjacent block as a prediction vector. However, a coding mode usable for the target block is restricted to the inter-layer inter-prediction coding mode in some cases. In this case, the prediction block generation unit 22 sets a vector obtained by enlarging the motion vector of the corresponding block located at the same position as the target block in the locally decoded reduced picture, as a prediction vector.

The prediction block generation unit 22 generates, for the target block, a prediction block for each usable prediction mode among the prediction modes of the intra-prediction coding mode, according to the prediction mode. For example, when the target block is a second-restriction target block, the prediction block generation unit 22 generates a prediction block for each prediction mode other than those in which pixels on the upper right of the target block are referred to. In addition, the prediction block generation unit 22 also sets, as a prediction block, the block obtained by up-sampling the block in locally decoded reduced picture located at the same position as the target block. A coding mode usable for the target block is restricted to the inter-layer intra-prediction coding mode in some cases. In this case, the prediction block generation unit 22 sets, as a prediction block, only the block in the locally decoded reduced picture obtained by up-sampling the block located at the same position as the target block.

The prediction block generation unit 22 outputs, for each block, the generated prediction block and prediction vector, to the coding-mode determination unit 23.

The coding-mode determination unit 23 determines, for each block in the coding-target picture, a coding mode to use for the block, on the basis of the prediction blocks and prediction vectors generated for the block. To determine the coding mode, the coding-mode determination unit 23 calculates, with respect to a target block, a coding cost which is an estimation value of the code amount, for each combination of the prediction block and prediction vector generated for the block. The coding-mode determination unit 23 determines the coding mode corresponding to the combination resulting in the lowest coding cost, as the coding mode to use for the target block.

The coding-mode determination unit 23 calculates, for each prediction block generated for the target block, prediction error, i.e., the sum SAD of the absolute values of the differences between pixels, according to the following equation in order to calculate the coding cost of the target block, for example.

SAD=Σ|OrgPixel−PredPixel|

In this equation, OrgPixel denotes the value of a pixel included in the target block in the coding-target picture, and PredPixel denotes the value of the corresponding pixel included in the prediction block.

The coding-mode determination unit 23 calculates a coding cost for each combination of the prediction block and the prediction vector generated for the target block according to the following equation.

Cost=SAD+λR

In this equation, R denotes an estimation value of the code amount for an item other than the orthogonal-transform coefficient, such as the prediction error between the motion vector and the prediction vector or a flag indicating the prediction mode in the intra-prediction coding mode. In addition, λ is a constant.

The coding-mode determination unit 23 may calculate the sum SATD of the absolute values of the pixels after Hadamard transform being performed on the difference image between the target block and the prediction block, instead of SAD.

The coding-mode determination unit 23 obtains the coding mode resulting in the lowest coding cost and then outputs the prediction block corresponding to the coding mode to the prediction error signal calculation unit 24. In addition, the coding-mode determination unit 23 outputs information identifying the coding mode, the prediction error between the motion vector and the prediction vector, and the like to the variable-length encoding unit 29.

The prediction error signal calculation unit 24 performs, for each block in the coding-target picture, difference operation between each pixel of the block and the corresponding pixel in the prediction block. The prediction error signal calculation unit 24 calculates the difference value corresponding to each pixel obtained through the difference operation, as a prediction error signal. The prediction error signal calculation unit 24 outputs the prediction error signal to the orthogonal-transform unit 25.

The orthogonal-transform unit 25 performs orthogonal transform on the prediction error signal for each block in the coding-target picture, to obtain a set of orthogonal-transform coefficients. For example, by performing discrete cosine transform (DCT) as an orthogonal transform process, the orthogonal-transform unit 25 obtains a set of DCT coefficients of each block as orthogonal-transform coefficients. The orthogonal-transform unit 25 outputs the set of orthogonal-transform coefficients of each block to the quantization unit 26.

The quantization unit 26 quantizes each orthogonal-transform coefficient, for each block in the coding-target picture, to calculate the quantization coefficient of the orthogonal-transform coefficient. This quantization is a process for expressing signal values included in a certain section, by the use of a single signal value. The certain section is referred to as a quantization step. For example, the quantization unit 26 quantizes the orthogonal-transform coefficient by rounding down a predetermined number of low-order bits corresponding to the quantization step of the orthogonal-transform coefficient. The quantization step is determined according to a quantization parameter. For example, the quantization unit 26 determines a quantization step to use, according to the function indicating the value of the quantization step with respect to the quantization parameter value. The function may be a monotone increasing function with respect to the quantization parameter value and is set in advance.

The quantization unit 26 may determine a quantization parameter in any of various methods of determining a quantization parameter that are based on a video coding standard, such as H.264. The quantization unit 26 may use, for example, a method of calculating a quantization parameter for MPEG-2 standard Test Model 5. Regarding the method of calculating a quantization parameter for MPEG-2 standard Test Model 5, refer to the website specified by the uniform resource locator (URL) http://www.mpeg.org/MPEG/MSSG/tm5/Ch10/Ch10.html.

The quantization unit 26 can reduce the number of bits to be used for representing each orthogonal-transform coefficient by performing the quantization process, consequently reducing the information amount included in the coding-target picture. The quantization unit 26 outputs the quantization coefficients to the decoding unit 27 and the variable-length encoding unit 29.

The decoding unit 27 generates, on the basis of the quantization coefficients of each block in the coding-target picture, a locally decoded picture to be referred to for encoding blocks subsequent to the block and pictures subsequent to the coding-target picture in the coding order. For the decoding, the decoding unit 27 performs inverse quantization on each quantization coefficient by multiplying the quantization coefficient by a predetermined number corresponding to the quantization step determined according to the quantization parameter. Through this inverse quantization, the set of orthogonal-transform coefficients, for example, the set of DCT coefficients, of each block is restored. Then, the decoding unit 27 performs an inverse orthogonal transform process on the set of orthogonal-transform coefficients for each block. For example, when the orthogonal-transform unit 25 performs DCT, the decoding unit 27 performs an inverse DCT process on each block. By performing inverse quantization and inverse orthogonal transform on each quantized signal, a prediction error signal including information approximately equivalent to that included in the prediction error signal before the coding is reproduced.

The decoding unit 27 adds, to the value of each pixel in the prediction block, the reproduced prediction error signal corresponding to the pixel. By carrying out these processes for each prediction block, the decoding unit 27 restores a block to be referred to for generating a prediction block for a block to be encoded subsequently. The decoding unit 27 may further perform deblocking filtering on the restored block. Every time the decoding unit 27 restores a block, the decoding unit 27 stores the restored block in the storage unit 28.

The storage unit 28 temporarily stores the restored blocks. By combining the restored blocks corresponding to a single picture in the coding order of the blocks, a locally decoded picture is obtained. The storage unit 28 stores a predetermined number of locally decoded pictures possible to be referred to for the coding-target picture and discards the locally decoded pictures from the one earliest in the coding order when the number of locally decoded pictures stored exceeds the predetermined number.

In addition, the storage unit 28 stores the motion vector of each block encoded in the inter-prediction coding.

The variable-length encoding unit 29 performs variable-length coding on each quantization coefficient of each block in the coding-target picture. The variable-length encoding unit 29 performs variable-length coding also on the prediction error for the motion vector used for generating each prediction block and so on. The variable-length encoding unit 29 outputs, to the multiplexing unit 17, encoded data of the picture, which is a bitstream in which encoded bits obtained by the variable-length coding are arranged in a predetermined order according to H.264. The variable-length encoding unit 29 can use a Huffman coding process, such as context-based adaptive variable length coding (CAVLC), or an arithmetic coding process, such as context-based adaptive binary arithmetic coding (CABAC), as a variable-length coding method.

The multiplexing unit 17 combines the encoded data of the reduced pictures output by the lower-layer encoding unit 12 and the encoded data of the pictures output by the upper-layer encoding unit 16, in a predetermined order. Moreover, the multiplexing unit 17 adds header information and the like according to H.264 to the combined encoded data and consequently obtains a bitstream including encoded video data. Further, the multiplexing unit 17 adds information indicating the ROI of each picture obtained by the ROI setting unit 14, to the bitstream. With this configuration, a video decoding device can decode only the ROI of each upper-layer picture independently.

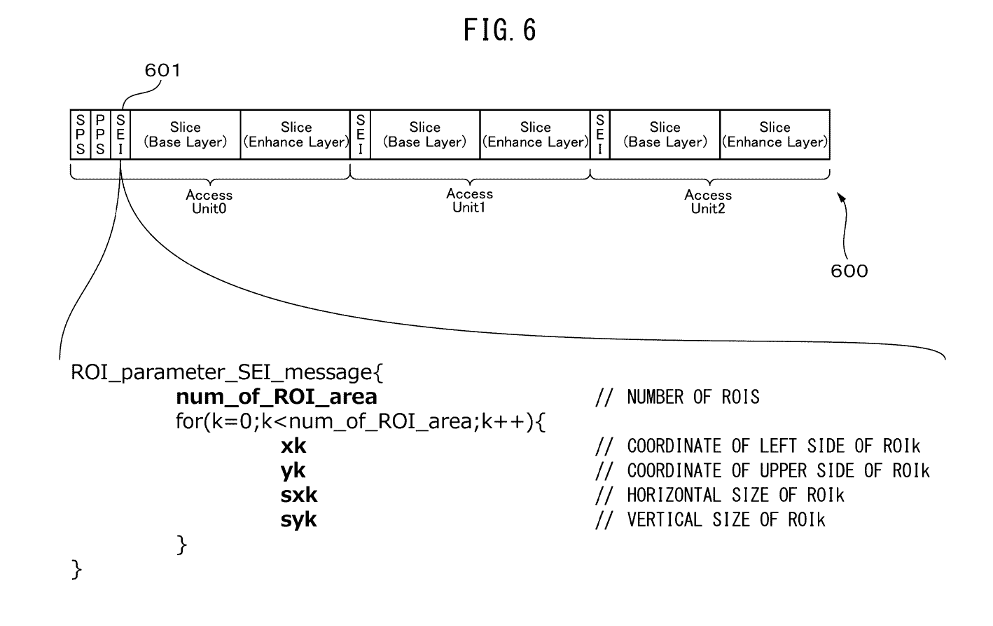

FIG. 6 is a diagram illustrating an example of a bitstream including encoded video data output by the multiplexing unit 17. In a bitstream 600, ROI_parameter_SEI message, which is information indicating an ROI, is inserted into an SEI message in an access unit set for each picture. ROI_parameter_SEI_message includes a parameter num_of_ROI_area, which indicates the number of set ROIs, as well as coordinates (xk,yk) of the pixel at the upper left corner of the ROI, horizontal size sxk of the ROI, and vertical size syk of the ROI, set for each ROI.

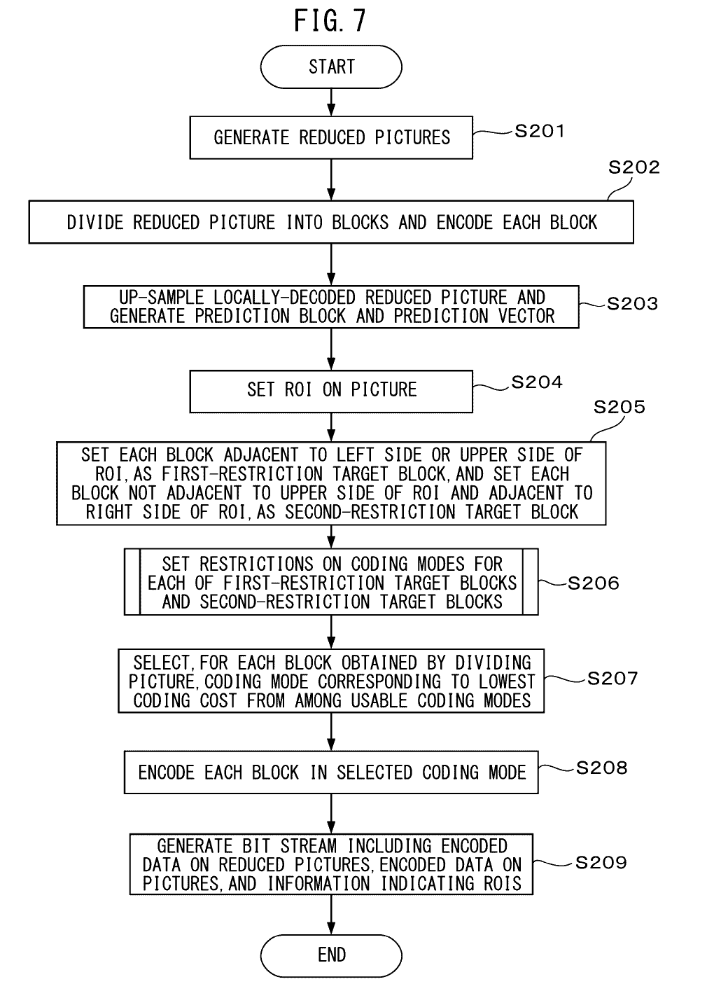

FIG. 7 is an operation flowchart of a video encoding process by the video encoding device 1. The video encoding device 1 encodes each picture according to the following operation flowchart.

The reduction unit 11 generates a reduced picture by down-sampling a coding-target picture (Step S201). Then, the lower-layer encoding unit 12 divides the reduced picture into blocks and encodes each block (Step S202).

The enlargement unit 13 generates a prediction block by up-sampling each block of the locally decoded reduced picture obtained by decoding each encoded reduced picture, and enlarges the motion vector according to the reduction ratio of the reduced picture, to generate a prediction vector (Step S203).

The ROI setting unit 14 sets an ROI in an upper-layer coding-target picture (Step S204). The coding-mode restriction unit 15 then sets each block adjacent to the left side or upper side of the ROI, as a first restriction-target block, and sets each block not adjacent to the upper side of the ROI but adjacent to the right side of the ROI, as a second-restriction target block (Step S205). The coding-mode restriction unit 15 sets, for each of the first-restriction target blocks and the second-restriction target blocks, restrictions on usable coding modes so as not to refer to any block outside the ROI of the coding-target picture (Step S206).

The upper-layer encoding unit 16 divides the upper-layer coding-target picture into blocks and selects, for each block, a coding mode resulting in the lowest coding cost from among the usable coding modes (Step S207). The upper-layer encoding unit 16 then encodes each block in the coding mode selected for the block (Step S208).

The multiplexing unit 17 generates a bitstream including encoded data of the coding-target picture, encoded data of the reduced picture, and information indicating the ROI (Step S209). The multiplexing unit 17 then outputs the bitstream. The video encoding device 1 terminates the video encoding process.

As described above, the video encoding device sets, as a restriction-target block, each block adjacent to the left side, upper side, or right side of the ROI set in an upper-layer picture. The video encoding device restricts, for each restriction-target block, usable coding modes to coding modes such as one in which a corresponding lower-layer block is referred to, so as not to refer to any block outside the ROI of the picture. With this configuration, the video encoding device can encode an upper-layer picture so that a video decoding device can decode only the ROI without setting any slice or tile for the upper-layer picture.

Next, a video decoding device configured to decode video data encoded by the above-described video encoding device is described. This video decoding device can decode only an ROI in an upper-layer picture included in the video data.

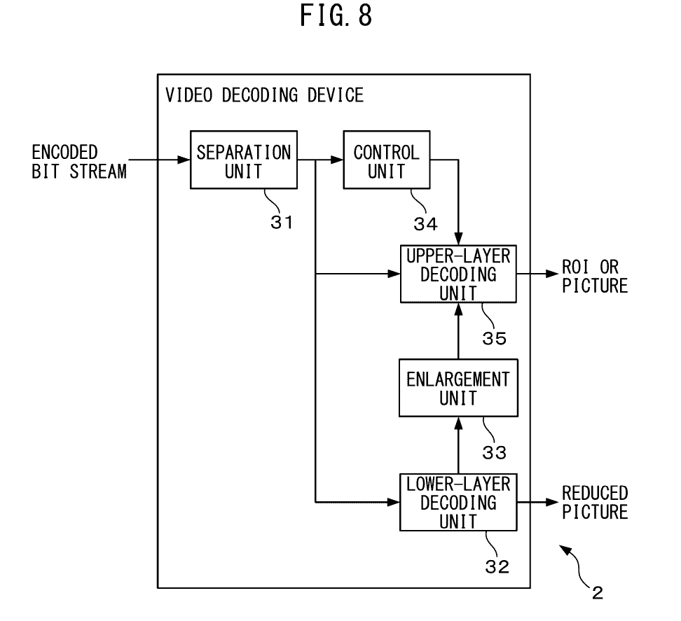

FIG. 8 is a schematic configuration diagram of a video decoding device according to an embodiment. A video decoding device 2 includes a separation unit 31, a lower-layer decoding unit 32, an enlargement unit 33, a control unit 34, and an upper-layer decoding unit 35. These units included in the video decoding device 2 are mounted as separate circuits in the video decoding device 2. Alternatively, these units included in the video decoding device 2 may be mounted in the video decoding device 2 as a single or multiple integrated circuits into which circuits implementing functions of these units are integrated. Alternatively, these units included in the video decoding device 2 may be functional modules implemented by a computer program executed on a processor included in the video decoding device 2.

The separation unit 31 extracts encoded data on lower-layer reduced pictures, encoded data on upper-layer pictures, and information indicating ROIs in the upper-layer pictures, from a bitstream including encoded video data. The separation unit 31 then outputs the encoded data on the lower-layer reduced pictures to the lower-layer decoding unit 32 and the encoded data on the upper-layer pictures to the upper-layer decoding unit 35. The separation unit 31 also outputs the information indicating the ROIs in the upper-layer pictures to the control unit 34.

The lower-layer decoding unit 32 decodes each lower-layer reduced picture. Specifically, the lower-layer decoding unit 32 performs variable-length decoding on the encoded data of the reduced picture. The lower-layer decoding unit 32 then reproduces quantization coefficients obtained by quantizing orthogonal-transform coefficients obtained by performing orthogonal transform on prediction error signals, for each block of the reduce picture.

The lower-layer decoding unit 32 performs inverse quantization for each block by multiplying each reproduced quantization coefficient by a predetermined number corresponding to a quantization step determined according to the quantization parameter acquired from the header information. Through this inverse quantization, the orthogonal-transform coefficients, for example, a set of DCT coefficients, of each block are restored. Subsequently, the lower-layer decoding unit 32 performs an inverse-orthogonal-transform process on each orthogonal-transform coefficient. By performing the inverse-quantization process and the inverse-orthogonal-transform process on the quantization coefficients, the prediction error signals of each block are reproduced.

The lower-layer decoding unit 32 identifies the coding mode used for each block, from the header information. When a target block is a block encoded in the inter-prediction coding mode, the lower-layer decoding unit 32 performs variable-length decoding on information specifying the prediction vector of the motion vector of the block and the prediction error. The lower-layer decoding unit 32 decodes the motion vector on the basis of the information specifying the prediction vector and the prediction error.

The lower-layer decoding unit 32 generates a prediction block for each block in the reduced picture, on the basis of an already-decoded reduced picture or a decoded region of the decoding-target reduced picture according to the coding mode used for the block.

The lower-layer decoding unit 32 reproduces each block by adding, to the value of each pixel in the prediction block corresponding to the block, the reproduce prediction error signal corresponding to the pixel. The lower-layer decoding unit 32 reproduces each reduced picture by combining the reproduced blocks of the reduced picture, in the coding order. The lower-layer decoding unit 32 stores the reproduced reduced picture in a memory (not illustrated) included in the lower-layer decoding unit 32 or accessible by the lower-layer decoding unit 32.

The enlargement unit 33 up-samples the blocks of each reduced picture to be referred to by the upper-layer decoding unit 35 for decoding the encoded upper-layer picture. The enlargement unit 33 also enlarges the motion vector of each block of the reduced picture.

For example, the enlargement unit 33 generates a prediction block having the same size as that of the corresponding block in the upper-layer picture, by applying an up-sampling filter defined in the scalable coding in H.264 to each block of the reduced picture. When the video decoding device 2 is based on a coding standard other than H.264, the enlargement unit 33 may apply a different up-sampling filter. The enlargement unit 33 enlarges the motion vector of each block of the reduced picture by multiplying each of the horizontal component and vertical component of the motion vector by the inverse of the corresponding reduction ratio. The enlargement unit 33 sets the motion vector thus enlarged as a prediction vector to be used for the coding of the corresponding motion vector of the upper-layer picture.

The enlargement unit 33 outputs the prediction block and the prediction vector to the upper-layer decoding unit 35.

The control unit 34 determines, for each upper-layer picture, whether to decode the entire picture or only a certain ROI in the picture. For the determination, for example, the control unit 34 receives an operation signal corresponding to a user operation and indicating whether to decode the entire picture or to decode a certain ROI, from a user interface unit (not illustrated), such as a keyboard or a mouse. When the operation signal indicates decoding the entire picture, the control unit 34 outputs, for each upper-layer picture, a decoding-target specifying signal indicating decoding the entire picture, to the upper-layer decoding unit 35. In this case, the decoding-target specifying signal includes, for example, a flag indicating decoding the entire picture. On the other hand, when the operation signal indicates decoding a certain ROI, the control unit 34 outputs, for each upper-layer picture, a decoding-target specifying signal indicating decoding a specified ROI, to the upper-layer decoding unit 35. In this case, the decoding-target specifying signal includes, for example, the values of the coordinates of the pixel on the upper left corner of the decoding-target ROI as well as the horizontal and vertical sizes of the ROI. The decoding-target ROI may be specified by the use of an ROI number included in the information indicating the ROI, for example. Alternatively, the decoding-target ROI may be specified by specifying a decoding-target region in the picture. In this case, the control unit 34 may specify an ROI included in the specified region, by referring to the information indicating the ROI. The position and the range of the specified region may be stored in advance in a memory included in the control unit 34.

Whether to decode the entire picture or only a certain ROI may be specified for the entire video data, or for each picture or every certain period (for example, 10 seconds to 10 minutes).

The upper-layer decoding unit 35 decodes each upper-layer picture in the encoded video data. In the decoding, the upper-layer decoding unit 35 can decode each block of the picture by carrying out a similar decoding process as that carried out for each block by the lower-layer decoding unit 32. When a decoding-target specifying signal specifies a certain ROI, the upper-layer decoding unit 35 determines, for each block, whether the block is included in the ROI, and decodes the block when the block is included in the ROI. Note that the upper-layer decoding unit 35 performs a variable-length decoding process on the encoded data of each block in the coding order of the blocks even when a decoding-target ROI is specified. This is because dependency between blocks is involved in the variable-length decoding process. The upper-layer decoding unit 35 may perform deblocking filtering on each decoded block.

The upper-layer decoding unit 35 reproduces the entire picture or the ROI by combining the decoded blocks. The upper-layer decoding unit 35 then rearranges the reproduced pictures or the ROIs in order of time to reproduce the video data. The upper-layer decoding unit 35 outputs the reproduced video data. The output video data is, for example, stored in an unillustrated storage device. Alternatively, the output video data is displayed by an unillustrated display device connected to the video decoding device 2.

When only the ROI is decoded for each upper-layer picture, the video decoding device 2 may encode each ROI again according to a predetermined video coding standard. This enables the size of each reencoded ROI to be smaller than that of the original picture, consequently reducing the data amount.

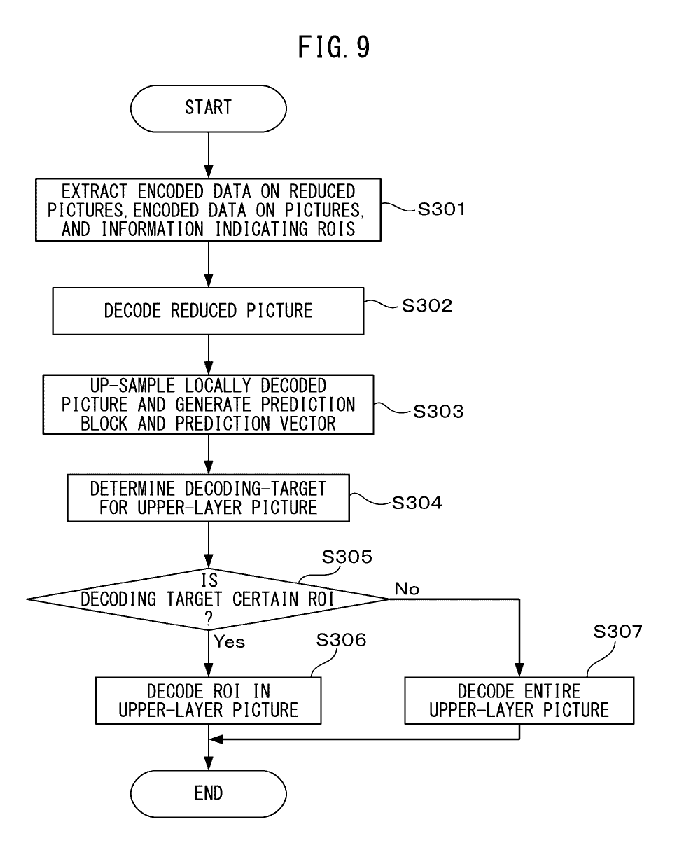

FIG. 9 is an operation flowchart of a video decoding process carried out by the video decoding device 2. For example, the video decoding device 2 carries out the video decoding process for each upper-layer picture included in encoded video data, according to the following operation flowchart.

The separation unit 31 extracts encoded data on lower-layer reduced pictures, encoded data on upper-layer pictures, and information indicating ROIs in the upper-layer pictures, from a bitstream including encoded video data (Step S301). The separation unit 31 then outputs the encoded data on the lower-layer reduced pictures to the lower-layer decoding unit 32 and the encoded data on the upper-layer pictures to the upper-layer decoding unit 35. The separation unit 31 also outputs the information indicating the ROIs in the upper-layer pictures to the control unit 34.

The lower-layer decoding unit 32 decodes the lower-layer reduced picture on the basis of the encoded data of each lower-layer reduced picture (Step S302). The enlargement unit 33 generates a prediction block by up-sampling each block of the decoded reduced picture and generates a prediction vector by enlarging the motion vector according to the reduction ratio of the reduced picture (Step S303).

The control unit 34 determines, for the upper-layer picture, a decoding target (i.e., the entire picture or a certain ROI) (Step S304). The control unit 34 then outputs a decoding-target specifying signal indicating the decoding target, to the upper-layer decoding unit 35.

The upper-layer decoding unit 35 determines whether the decoding target is a certain ROI by referring to the decoding-target specifying signal (Step S305). When the decoding-target specifying signal indicates decoding of a certain ROI (Yes in Step S305), the upper-layer decoding unit 35 decodes the certain ROI (Step S306). On the other hand, when the decoding-target specifying signal indicates decoding of the entire picture (No in Step S305), the upper-layer decoding unit 35 decodes the entire picture (Step S307). After Step S306 or S307, the video decoding device 2 terminates the video decoding process.

As described above, the video decoding device can decode only an ROI in an upper-layer picture without decoding any region outside the ROI. Hence, the video decoding device can reduce the computation amount when only an ROI is decoded for an upper-layer picture.

According to a modified example, the ROI setting unit of the video encoding device may divide each upper-layer picture into multiple ROIs. The coding-mode restriction unit of the video encoding device may set first-restriction target blocks for each ROI of the picture, the ROI being set for each picture. In this modified example, no second-restriction target block may be set. In this case, the region between two adjacent rows of first-restriction target blocks corresponds to a single ROI.

According to the modified example, the video encoding device encodes each upper-layer picture so that the video decoding device can perform decoding on an ROI-by-ROI basis. With this configuration, it is possible to set, for example, a region to be decoded partially in a corresponding upper-layer picture by referring to a decoded reduce picture, after video data is encoded.

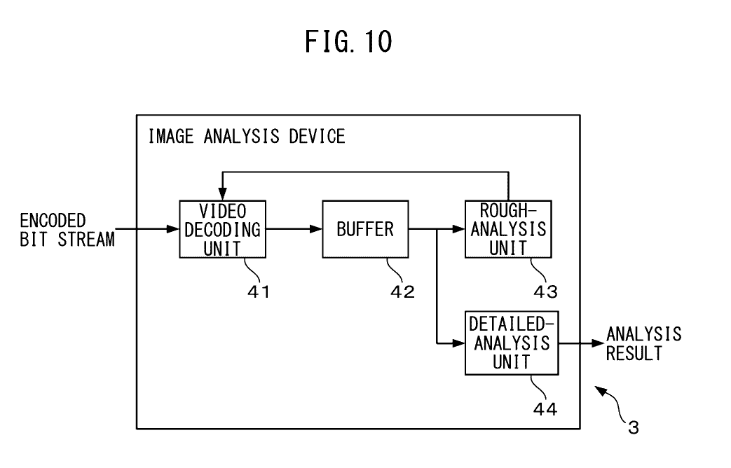

FIG. 10 is a schematic configuration diagram of an image analysis device corresponding to the modified example. An image analysis device 3 includes a video decoding unit 41, a buffer 42, a rough-analysis unit 43, and a detailed-analysis unit 44. These units included in the image analysis device 3 are mounted as separate circuits in the image analysis device 3. Alternatively, these units included in the image analysis device 3 may be mounted in the image analysis device 3 as a single or multiple integrated circuits into which circuits implementing functions of these the units are integrated. Alternatively, the image decoding unit 41, the rough-analysis unit 43, and the detailed-analysis unit 44 among the units included in the image analysis device 3 may be functional modules implemented by a computer program executed on a processor included in the image analysis device 3. The buffer 42 may be implemented by a memory circuit included in the image analysis device 3.

The video decoding unit 41 includes a similar configuration to that of the video decoding device 2 according to the above-described embodiment. The video decoding unit 41 decodes the lower-layer reduced pictures corresponding to the pictures included in video data encoded by the video encoding device 1 according to the above-described embodiment. The video decoding unit 41 then stores the decoded reduced picture in the buffer 42.

The video decoding unit 41 decodes the ROI specified by the rough-analysis unit 43 in each upper-layer picture. The video decoding unit 41 outputs the decoded ROI to the detailed-analysis unit 44. The video decoding unit 41 may store the decoded ROI in the buffer 42.

The rough-analysis unit 43 is an example of a partial-decoding-region setting unit, and is configured to read a decoded reduced picture from the buffer 42 and set a decoding-target partial region in the corresponding upper-layer picture, on the basis of the reduced picture. The rough-analysis unit 43 then identifies each ROI including the decoding-target partial region.

The rough-analysis unit 43 can set a decoding-target partial region by a similar method as that employed by the ROI setting unit 14 of the video encoding device 1 to set an ROI, for example. Specifically, the rough-analysis unit 43 acquires information specifying the coordinates of the upper left corner and the lower right corner of the partial region, or the upper left corner of the partial region and the horizontal and vertical sizes of the partial region, via a user interface (not illustrated), such as a keyboard or a mouse. The rough-analysis unit 43 then sets the partial region according to the information. In this case, the user may set a decoding-target partial region by, for example, checking the decoded reduced picture on a display device and specifies the partial region via a user interface unit.

Alternatively, the rough-analysis unit 43 may use, for each reduced picture, a classifier configured to detect a predetermined object, to detect a region including the object in the reduced picture. The rough-analysis unit 43 may then set a region corresponding to the detected region in the picture, as a decoding-target partial region.

The rough-analysis unit 43 identifies each ROI including at least part of the decoding-target partial region, in each reduced picture. The rough-analysis unit 43 then outputs information specifying each identified ROI in each reduced picture, to the video decoding unit 41.

The detailed-analysis unit 44 analyzes the ROI in each upper-layer picture decoded by the video decoding unit 41. For example, the detailed-analysis unit 44 may use, for the ROI, a classifier configured to determine the attribute of a predetermined object and determine the attribute of the object in the ROI.

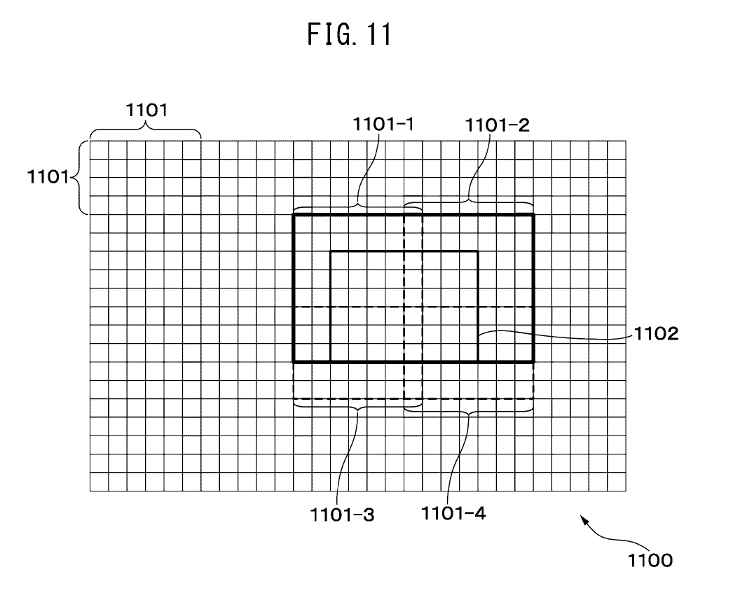

FIG. 11 is a diagram illustrating an example of ROIs set in an upper-layer picture and a decoding-target partial region specified by the rough-analysis unit 43, in the modified example. In the example, in a picture 1100, four ROIs 1101 are set in a horizontal direction, and three ROIs 1101 are set in a vertical direction, in advance. When a partial region 1102 set by the rough-analysis unit 43 is set, four ROIs 1101-1 to 1101-4 each including part of the partial region 1102 are decoding targets. With respect to each of the ROIs 1101-3 and 1101-4, which are two lower ROIs among the ROIs 1101-1 to 1101-4, only the blocks down to the lower side of the partial region 1102 may be decoded. This is because the blocks in a picture are normally encoded and decoded in the raster scan order, and hence the blocks located below the lower side of the partial region 1102 are not used for decoding the partial region 1102.

According to still another modified example, the coding-mode restriction unit of the video encoding device may allow the use of the inter-prediction coding mode for each second-restriction target block, with such restrictions that the motion vector of the upper right block is not used as a prediction vector for the block.

In some cases, the video encoding device is based on a video coding standard that allows the use of the motion vector of the block located at the same position as that of a target block in an already encoded picture (referred to as a temporal vector below), as a prediction vector. In this case, the coding-mode restriction unit may allow the use of the inter-prediction coding mode for each first-restriction target block by restricting a prediction vector of the block to the temporal vector.

According to the above-described embodiment, the position and size of an ROI set in an upper-layer picture may be different for each picture in some cases. In such a case, no ROI may be present in a referable range in a locally decoded picture to be referred to when any of the inter-prediction coding mode and the inter-layer inter-prediction coding mode is used for each block in the ROI in a coding-target picture. With no ROI being present in the referable range, the referable range may not be decoded in the decoding of the encoded picture. In view of this, the coding-mode restriction unit may restricts the use of coding modes for a block in the ROI so as not to use the inter-prediction coding mode or the inter-layer inter-prediction coding mode, when no ROI is set in the referable range of the locally decoded picture to be referred to for the block.

The video encoding device and the video decoding device according to any of the above-described embodiment and modified examples of the embodiment may be used, for example, for a monitoring system configured to detect a certain object in video data generated by a monitoring camera and set a region including the detected object as an ROI. Alternatively, the video encoding device and the video decoding device according to any of the above-described embodiment and modified examples of the embodiment may be used, for example, for an image analysis system configured to determine whether a certain object is detected in video data generated by a monitoring camera, on the basis of reduced pictures. In the image analysis system, upon detection of an object, the attribute of the object may be determined on the basis of a corresponding upper-layer picture.

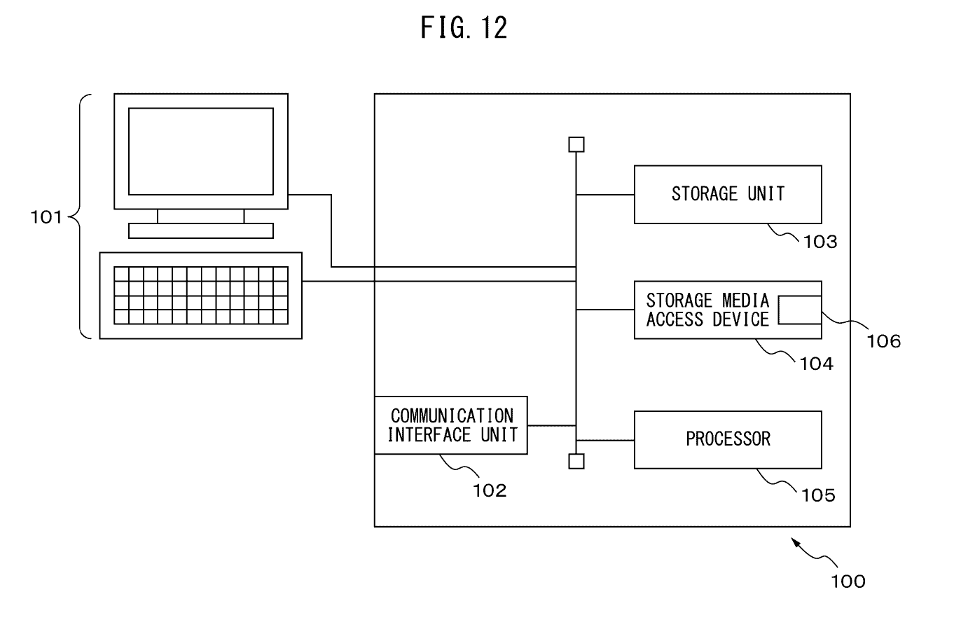

FIG. 12 is a configuration diagram of a computer configured to operate as the video encoding device or the video decoding device according to any of the above-described embodiment and modified examples of the embodiment by the operation of a computer program implementing the functions of the units of the video encoding device or the video decoding device. The computer is usable in, for example, the above-described monitoring system or image analysis system.

A computer 100 includes a user interface unit 101, a communication interface unit 102, a storage unit 103, a storage medium access device 104, and a processor 105. The processor 105 is connected to the user interface unit 101, the communication interface unit 102, the storage unit 103, and the storage medium access device 104 via a bus, for example.

The user interface unit 101 includes, for example, input devices, such as a keyboard and a mouse, and a display device, such as a liquid crystal display. Alternatively, the user interface unit 101 may include a device in which input devices and a display device are integrated, such as a touch panel display. The user interface unit 101 outputs an operation signal for selecting video data to encode or video data to decode to the processor 105, for example, according to a user operation.

In addition, the user interface unit 101 may output an operation signal for setting an ROI in an upper-layer picture in the video data to the processor 105, according to a user operation, at the time of encoding the video data. Alternatively, the user interface unit 101 may output an operation signal for specifying a decoding target in an upper-layer picture to the processor 105 according to a user operation, at the time of decoding encoded video data.

The communication interface unit 102 may include a communication interface for connecting the computer 100 to a device for generating video data, for example, a video camera, and a control circuit of the communication interface. Such a communication interface may be, for example, a universal serial bus (USB) or a high-definition multimedia interface (HDMI) (registered trademark).

The communication interface unit 102 may also include a communication interface for connecting to a communication network based on a communication standard such as Ethernet (registered trademark), and a control circuit of the communication interface.

In this case, the communication interface unit 102 acquires video data to encode from another device connected to the communication network and passes the data to the processor 105. The communication interface unit 102 may output encoded video data received from the processor 105 to another device via the communication network. The communication interface unit 102 may acquire a bitstream including encoded video data to be decoded, from another device connected to the communication network, and pass the bitstream to the processor 105.

The storage unit 103 includes, for example, a readable/writable semiconductor memory and a read-only semiconductor memory. The storage unit 103 stores a computer program for executing a video encoding process and a computer program for executing a video decoding process to be executed on the processor 105, and data generated during or as a result of these processes.

The storage medium access device 104 is a device configured to access the storage medium 106, for example, a magnetic disk, a semiconductor memory card, or an optical storage medium. The storage medium access device 104, for example, reads the computer program for the video encoding process or the computer program for the video decoding process, to be executed on the processor 105, stored in the storage medium 106, and passes the program to the processor 105.

The processor 105 includes at least one of a central processing unit (CPU), a graphics processing unit (GPU), and a numeric processor, for example. The processor 105 executes the computer program for the video encoding process by any of the above-described embodiment and modified examples of the embodiment, to generate encoded video data. The processor 105 then stores the generated encoded video data in the storage unit 103 or outputs the generated encoded video data to another device via the communication interface unit 102. Alternatively, the processor 105 executes the computer program for the video decoding process according to any of the above-described embodiment and modified examples of the embodiment, to decode the encoded video data. In the decoding, the processor 105 may decode only the ROI in each upper-layer picture. The processor 105 causes the user interface unit 101 to display the decoded picture on the display device.

The computer program for the video encoding process and the computer program for the video decoding process according to any of the above-described embodiment and modified examples may be provided in the form of being recorded in a computer-readable medium. However, such a recording medium does not include any carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A video encoding device comprising:
a processor configured to:
down-sample a picture included in video data to generate a reduced picture;
divide the reduced picture into a plurality of first blocks;
encode each of the plurality of first blocks;
set a first region in the picture;
restrict a coding mode usable for each second block included in the first region among a plurality of second blocks divided from the picture, among a plurality of coding modes each defining a method of generating a prediction block, to a first coding mode which refers to the first block in the reduced picture corresponding to the second block or a second coding mode which refers to the first region in the picture;
generate, for each second block in the first region, a prediction block in accordance with the first coding mode or the second coding mode; and
encode a prediction error signal obtained by performing difference calculation between the prediction block and the second block.

2. The video encoding device according to claim 1, wherein the restriction of the coding mode restricts the coding mode usable for the second block adjacent to a left side or an upper side of the first region among the second blocks in the first region, to the first coding mode.

3. The video encoding device according to claim 2, wherein the first coding mode includes:
an inter-layer intra-prediction coding mode in which a block obtained by up-sampling the first block in the reduced picture corresponding to the second block adjacent to the left side or the upper side of the first region is set as the prediction block; and
an inter-layer inter-prediction coding mode in which, for the second block adjacent to the left side or the upper side of the first region, a vector obtained by enlarging a second motion vector for the first block in the reduced picture corresponding to the second block, according to a reduction ratio of the reduced picture to the picture, is set as a prediction vector for motion vector for generating the prediction block by performing motion compensation on a different picture previous to the picture in a coding order.

4. The video encoding device according to claim 2, wherein the restriction of the coding mode restricts a coding mode usable for the second block adjacent to right side of the first region but not adjacent to the upper side of the first region among the second blocks in the first region, to the first coding mode and an intra-prediction coding mode among the second coding mode, in which the prediction block is generated from a pixel adjacent to the left side or the upper side the second block.

5. The video encoding device according to claim 1, wherein the setting the first region includes:
detecting a predetermined object from the picture using a classifier configured to detect the predetermined object, and
setting a region including the detected predetermined object as the first region.

6. A video encoding method comprising:
down-sampling a picture included in video data to generate a reduced picture;
dividing the reduced picture into a plurality of first blocks;
encoding each of the plurality of first blocks;
setting a first region in the picture;
restricting a coding mode usable for each second block included in the first region among a plurality of second blocks divided from the picture, among a plurality of coding modes each defining a method of generating a prediction block, to a first coding mode which refers to the first block in the reduced picture corresponding to the second block or a second coding mode which refers to the first region in the picture;
generating, for each second block in the first region, a prediction block in accordance with the first coding mode or the second coding mode; and
encoding a prediction error signal obtained by performing difference calculation between the prediction block and the second block.

7. The video encoding method according to claim 6, wherein the restriction of the coding mode restricts the coding mode usable for the second block adjacent to a left side or an upper side of the first region among the second blocks in the first region, to the first coding mode.

8. The video encoding method according to claim 7, wherein the first coding mode includes:
an inter-layer intra-prediction coding mode in which a block obtained by up-sampling the first block in the reduced picture corresponding to the second block adjacent to the left side or the upper side of the first region is set as the prediction block; and
an inter-layer inter-prediction coding mode in which, for the second block adjacent to the left side or the upper side of the first region, a vector obtained by enlarging a second motion vector for the first block in the reduced picture corresponding to the second block, according to a reduction ratio of the reduced picture to the picture, is set as a prediction vector for motion vector for generating the prediction block by performing motion compensation on a different picture previous to the picture in a coding order.

9. The video encoding method according to claim 7, wherein the restriction of the coding mode restricts a coding mode usable for the second block adjacent to right side of the first region but not adjacent to the upper side of the first region among the second blocks in the first region, to the first coding mode and an intra-prediction coding mode among the second coding mode, in which the prediction block is generated from a pixel adjacent to the left side or the upper side the second block.

10. The video encoding method according to claim 6, wherein the setting the first region includes:
detecting a predetermined object from the picture using a classifier configured to detect the predetermined object, and
setting a region including the detected predetermined object as the first region.

11. A video decoding device comprising:
a processor configured to:
extract, from encoded video data, first encoded data obtained by encoding each of the plurality of first blocks obtained by dividing a reduced picture generated by down-sampling a picture included in the video data, region information indicating a first region set in the picture, and second encoded data obtained by encoding a second block in the first region among a plurality of second blocks divided from the picture in accordance with a first coding mode which refers to the first block in the reduced picture corresponding to the second block or a second coding mode which refers to the first region in the picture;
decode the reduced picture from the first encoded data; and
decode the first region of the picture from the second encoded data.

12. The video decoding device according to claim 11, wherein
a plurality of the first regions are set in the picture, and
the processor further configured to:
set a partial region as a decoding-target in the picture on the basis of the decoded reduced picture;
specify a first region including the partial region among the plurality of first regions; and
instruct the second decoding unit to decode the specified first region.

13. A video decoding method comprising:
extracting, from encoded video data, first encoded data obtained by encoding each of the plurality of first blocks obtained by dividing a reduced picture generated by down-sampling a picture included in the video data, region information indicating a first region set in the picture, and second encoded data obtained by encoding a second block in the first region among a plurality of second blocks divided from the picture in accordance with a first coding mode which refers to the first block in the reduced picture corresponding to the second block or a second coding mode which refers to the first region in the picture;
decoding the reduced picture from the first encoded data; and
decoding the first region of the picture from the second encoded data.

14. The video decoding method according to claim 13, wherein
a plurality of the first regions are set in the picture, and
the video decoding method further comprises:
setting a partial region as a decoding-target in the picture on the basis of the decoded reduced picture;
specifying a first region including the partial region among the plurality of first regions; and
instructing the second decoding unit to decode the specified first region.
